(19) United States
(12) Patent Application Publication
(10) Pub. No.: US 2025/0237850 A1
(43) Pub. Date: Jul. 24, 2025

(54) IMAGING LENS

(71) Applicant: Young Optics Inc., Hsinchu Science Park (TW)

(72) Inventors: HONG-HSUAN SHIAO, Hsinchu Science Park (TW); CHIEN-HSIUNG TSENG, Hsinchu Science Park (TW)

(21) Appl. No.: 18/418,743

(22) Filed: Jan. 22, 2024

(51) Int. Cl. G02B 9/62

(52) U.S. Cl. CPC G02B 9/62

(57) ABSTRACT

An imaging lens includes a first lens, a second lens, a third lens, a fourth lens, a fifth lens and a sixth lens with refractive powers arranged in order from an object side to an image side of the imaging lens. The imaging lens is configured to focus only in a wavelength range of infrared light, and the imaging lens satisfies the conditions of Fno<1.6, 90°<DFOV<140° and LT/EFL<5.0, where Fno is an F-number of the imaging lens, DFOV is a maximum diagonal field of view of the imaging lens, EFL is an effective focal length of the imaging lens, and LT is a distance measured along an optical axis between two outermost lens surfaces with refractive powers at opposite ends of the imaging lens.

### BACKGROUND

### Field of the Invention

The invention relates to an imaging lens, and particularly to an imaging lens suitable for infrared imaging applications.

### Description of the Related Art

An infrared imaging lens is often used with in-vehicle cameras, surveillance cameras, or action cameras. For example, the infrared imaging lens is often used as an imaging lens for a laser detection/ranging system or a driver monitoring systems. In addition, lenses commonly used in consumer electronic applications may not provide reliable performance and clear vision in extreme temperature situations. Therefore, it is desirable to provide an imaging lens that has a small volume, a wide viewing angle and a wide operating temperature range and can provide good infrared imaging quality.

### BRIEF SUMMARY OF THE INVENTION

In order to achieve one or a portion of or all of the objects or other objects, one embodiment of the invention provides an imaging lens including a first lens, a second lens, a third lens, a fourth lens, a fifth lens and a sixth lens with refractive powers arranged in order from an object side to an image side of the imaging lens. A total number of lenses with refractive powers of the imaging lens is at most eight. An aperture stop divides the lenses with refractive powers to define a first lens group between the object side and the aperture stop, and the first lens group has a negative refractive power. The imaging lens is configured to focus only in a wavelength range of infrared light, and the imaging lens satisfies the conditions of Fno<1.6, 90°<DFOV<140° and LT/EFL<5.0, where Fno is an F-number of the imaging lens, DFOV is a maximum diagonal field of view of the imaging lens, EFL is an effective focal length of the imaging lens, and LT is a distance measured along an optical axis between two outermost lens surfaces with refractive powers at opposite ends of the imaging lens.

Another embodiment of the invention provides an imaging lens including a first lens, a second lens, a third lens, a fourth lens, a fifth lens and a sixth lens with refractive powers arranged in order from an object side to an image side of the imaging lens. A total number of lenses with refractive powers of the imaging lens is at most eight. An aperture stop divides the lenses with refractive powers to define a first lens group between the object side and the aperture stop, and the first lens group has a negative refractive power. The imaging lens is configured to only focus on infrared spectrums, and the imaging lens satisfies the conditions of Fno<1.6, 90°<DFOV<140° and 9 mm<IMH<12 mm, where Fno is an F-number of the imaging lens, DFOV is a maximum diagonal field of view of the imaging lens, and IMH is a maximum image height.

Through the designs of various embodiments of the invention, the imaging lens can provide at least one of the advantages of wide viewing angles, large effective apertures, low thermal drift, wide working temperature ranges, and high-resolution infrared imaging qualities.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

FIG. 1 shows a cross-sectional illustration of an imaging lens according to a first embodiment of the invention.

FIG. 2A and FIG. 2B respectively show field curvature and distortion aberration curves of the imaging lens shown in FIG. 1.

FIG. 3 shows a cross-sectional illustration of an imaging lens according to a second embodiment of the invention.

FIG. 4A and FIG. 4B respectively show field curvature and distortion aberration curves of the imaging lens shown in FIG. 3.

FIG. 5 shows a cross-sectional illustration of an imaging lens according to a third embodiment of the invention.

FIG. 6A and FIG. 6B respectively show field curvature and distortion aberration curves of the imaging lens shown in FIG. 5.

FIG. 7 shows a cross-sectional illustration of an imaging lens according to a fourth embodiment of the invention.

FIG. 8A and FIG. 8B respectively show field curvature and distortion aberration curves of the imaging lens shown in FIG. 7.

### DETAILED DESCRIPTION OF THE INVENTION

In the following detailed description of the preferred embodiments, directional terminology, such as “top,” “bottom,” “front,” “back,” etc., is used with reference to the orientation of the Figure(s) being described. The components of the invention can be positioned in a number of different orientations. As such, the directional terminology is used for purposes of illustration and is in no way limiting. Further, “First,” “Second,” etc, as used herein, are used as labels for nouns that they precede, and do not imply any type of ordering (e.g., spatial, temporal, logical, etc.).

The term “lens” refers to an element made from a partially or entirely light-transmissive material with optical power. The material commonly includes plastic or glass.

In an imaging system, an object side may refer to one side of an optical path of an imaging lens comparatively near a subject to be picked-up, and an image side may refer to other side of the optical path comparatively near a photosensor.

A certain region of an object side surface (or an image side surface) of a lens may be convex or concave. Herein, a convex or concave region is more outwardly convex or inwardly concave in the direction of an optical axis as compared with other neighboring regions of the object/image side surface.

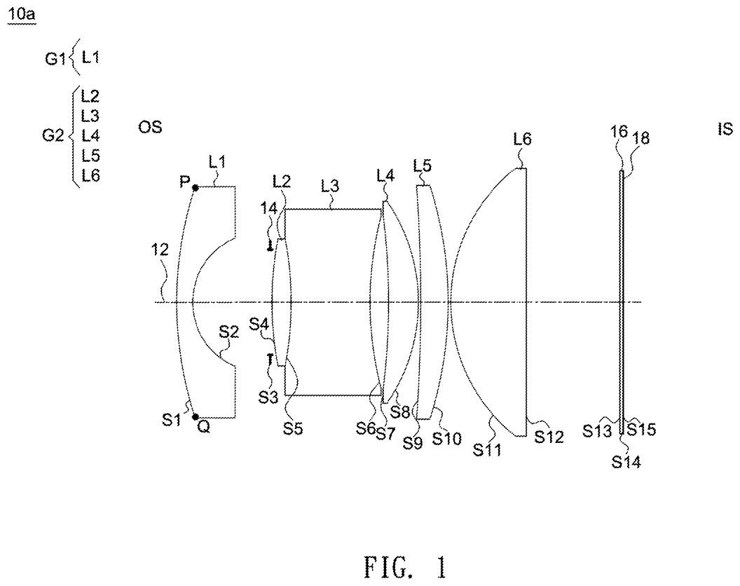

FIG. 1 shows a cross-sectional illustration of an imaging lens according to a first embodiment of the invention. Referring to FIG. 1, in this embodiment, an imaging lens 10a includes a first lens group G1, a second lens group G2, and an aperture stop 14 disposed between the first lens group G1 and the second lens group G2. The first lens group G1 has a negative refractive power and includes a lens L1, the second lens group G2 has a positive refractive power and includes a lens L2, a lens L3, a lens L4, a lens L5 and a lens L6 arranged in order from the object side OS to the image side IS. The lenses L1-L6 have refractive powers of negative, positive, negative, positive, positive, positive, respectively. Furthermore, an optical filter 16 and an image sensor (not shown) can be arranged on the image side IS. The optical filter 16 may be a plate coated with a filter film that can filter out visible light. An image plane (infrared focal plane) of the imaging lens 10a on the image sensor is marked as 18. Besides, in this embodiment, the optical filter 16 is disposed on one side of the second lens group G2 away from the first lens group G1. The aperture stop 14 is a light-blocking element that limits the amount of light passing through the imaging lens 10a. In other embodiment, the aperture stop 14 is defined by an inner diameter of a lens barrel and thus is not an independent optical element. Light from a subject to be captured may enter the imaging lens 10a, pass through the lens L1, the aperture stop 14, the lens L2, the lens L3, the lens L4, the lens L5, the lens L6 and the optical filter 16 in succession, and finally forms an image on the image plane 18.

In each of the following embodiments, the object side OS is located on the left side and the image side IS is located on the right side of each figure, and thus this is not repeatedly described in the following for brevity. In this embodiment, the aperture stop 14 is disposed between the lens L1 and the lens L2, and each of the lenses L1-L6 is a glass spherical lens, but the invention is not limited thereto. A glass lens may provide high light transmittance to improve imaging quality and high hardness to enhance wear resistance. Besides, the relatively low thermal expansion coefficient of a glass lens is allowed to reduce thermal drift of the imaging lens 10a and thus enhance imaging quality. In this embodiment, the lens L2 and the lens L3 are paired together, such as being cemented to each other, to form a doublet lens to reduce stray light propagating in the imaging lens 10a and allow for more relaxed tolerances in manufacturing the imaging lens 10a to thus improve the yield rate.

In at least some embodiments of the invention, the imaging lens is configured to focus only in a wavelength range of infrared light (such as about 940-970 nm). In at least some embodiments of the invention, an F-number Fno of the imaging lens is smaller than 1.6, a total number of lenses with refractive powers of the imaging lens is at most eight, and the aperture stop is disposed between a first lens and a third lens (counting from the object side OS), but the number, shape and optical characteristic of lenses may vary according to actual needs.

In at least some embodiments of the invention, the imaging lens may satisfy a condition of LT/EFL<5.0, and preferably a condition of LT/EFL<4.65, where EFL is an effective focal length of the imaging lens, and LT is a total lens length that is a distance measured along the optical axis 12 between two outermost lens surfaces with refractive powers at opposite ends of the imaging lens (such as the surface S1 and the surface S12 shown in FIG. 1). Meeting the above conditions may achieve a compromise between miniaturization and high optical performance and allow for an optimized proportion of a photosensor to the total lens length LT.

In at least some embodiments of the invention, the image lens may satisfy a condition of 9 mm<IMH<12 mm, and preferably a condition of 9.6 mm<IMH<11 mm, where IMH is a maximum image height. In at least some embodiments of the invention, the image lens may satisfy a condition of 0.2<IMH/LT<0.3, where IMH is a maximum image height, and LT is a total lens length that is a distance measured along the optical axis 12 between two outermost lens surfaces with refractive powers at opposite ends of the imaging lens (such as the surface S1 and the surface S12 shown in FIG. 1). Meeting the condition of 0.2<IMH/LT<0.3 may provide optimized values for the total lens length LT and the image height IMH. Specifically, if the ratio IMH/LT is lower than the lower limit (0.2), the total lens length LT may be too large for miniaturization, or the image height IMH may be too small to complicate the fabrication and assembly of the optical lens. In contrast, if the ratio IMH/LT is greater than the lower limit (0.3), the total lens length LT may be too short to result in a sensitive lens system that makes it challenging to establish appropriate manufacturing tolerances, or the image height IMH may be excessively large to obstruct miniaturization of the lens system.

Each lens may be assigned a parameter of “lens diameter”. For example, as shown in FIG. 1, the lens L1 has an object-side surface S1 and an image-side surface S2, each lens surface defines two outermost turning points P and Q at opposite ends of the optical axis 12, and a maximum distance between turning points P and Q in the direction perpendicular to the optical axis 12 is referred to as a lens diameter or an outside diameter. In at least some embodiments, the imaging lens may satisfy conditions of 0.5<D1/LT<0.65 and 0.5<DL/LT<0.65, where D1 is a lens diameter of the lens closest to the object side OS (such as the lens L1 shown in FIG. 1), DL is a lens diameter of the lens closest to the image side IS (such as the lens L6 shown in FIG. 1), and LT is the total lens length. Meeting the condition of 0.5<D1/LT<0.65 may facilitate light converging capability of lenses to allow for better optical performance in a limited space. Besides, meeting the condition of 0.5<DL/LT<0.65 means that a ratio of a lens diameter of the lens closest to the image side to the total lens length is sufficiently large to facilitate light collection.

A diagonal field of view (DFOV) refers to a light collection angle of the optical surface closest to the object side; that is, the DFOV is a full field of view measured diagonally. In at least some embodiments, the imaging lens satisfied a condition of 90°<DFOV<140°, and preferably 110°<DFOV<130°.

In this embodiment, the imaging lens 10a includes six lenses with refractive powers. As to the imaging lens 10a of this embodiment, an effective focal length (EFL) is 10.82 mm, an F-number (F #) is 1.3, a diagonal field of view DFOV is 124 degrees, a total track length (an axial distance between the object side surface of the lens closest to the object side OS and the image plane 18) TTL is 56.5 mm, a total lens length LT is 43.82 mm, a maximum image height IMH is 10.53 mm, a lens diameter D1 of the lens closest to the object side OS is 26.2 mm, a lens diameter DL of the lens closest to the image side IS is 29.3 mm, D1/LT=0.60, DL/LT=0.67, LT/EFL=4.05, and IMH/LT=0.24.

Detailed optical data and design parameters of the optical lens 10a are shown in Table 1 below. Note the data provided below are not used for limiting the invention, and those skilled in the art may suitably modify parameters or settings of the following embodiment with reference of the invention without departing from the scope or spirit of the invention.

Table 1 lists the values of parameters for each lens of an imaging system. The field heading “radius of curvature” shown in Table 1 is a reciprocal of the curvature. When a lens surface has a positive radius of curvature, the center of the lens surface is located towards the image side. When a lens surface has a negative radius of curvature, the center of the lens surface is located towards the object side. The field heading “interval” represents a distance between two adjacent surfaces along the optical axis 12 of the imaging lens 10a. For example, an interval of the surface S1 is a distance between the surface S1 and the surface S2 along the optical axis 12, an interval of the surface S2 is a distance between the surface S2 and the surface S3 along the optical axis 12. Further, the interval, refractive index and Abbe number of any lens listed in the column of “Object description” show values in a horizontal row aligned with the position of that lens, so that related descriptions are omitted for sake of brevity.

TABLE 1

| | | Radius of | Interval | Refractive | Abbe |
|---|---|---|---|---|---|
| Object description | Surface | curvature(mm) | (mm) | index (nd) | number (Vd) |
| Lens L1(meniscus) | S1 | 44.457 | 1.944 | 1.589 | 61 |
| | S2 | 8.594 | 9.806 | | |
| Aperture stop 14 | S3 | INF | 0.200 | | |
| Lens L2(bi-convex) | S4 | 43.987 | 2.433 | 1.986 | 16 |
| Lens L3(bi-concave) | S5 | −37.417 | 9.794 | 1.689 | 31 |
| | S6 | 37.417 | 2.375 | | |
| Lens L4(meniscus) | S7 | −85.132 | 3.808 | 2.001 | 29 |
| | S8 | −21.701 | 0.200 | | |
| Lens L5(meniscus) | S9 | −164.408 | 3.490 | 2.001 | 29 |
| | S10 | −45.415 | 0.200 | | |
| Lens L6 | S11 | 20.549 | 9.566 | 1.497 | 82 |
| (plano-convex) | | | | | |
| | S12 | INF | 12.144 | | |
| optical filter 16 | S13 | INF | 0.500 | 1.517 | 64 |
| | S14 | INF | 0.040 | | 61 |
| Image plane 18 | S15 | INF | 0.000 | | |

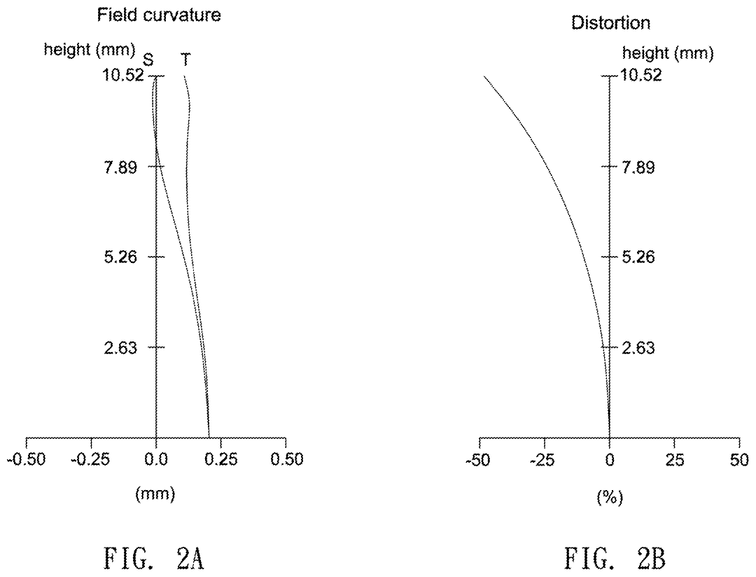

FIG. 2A and FIG. 2B respectively show field curvature and distortion aberration curves of the imaging lens 10a measured at a wavelength of 940 nm. Because the graphs shown in FIG. 2A and FIG. 2B are all within the standard range, it can be verified that the imaging lens 10a can achieve high-resolution infrared imaging effects.

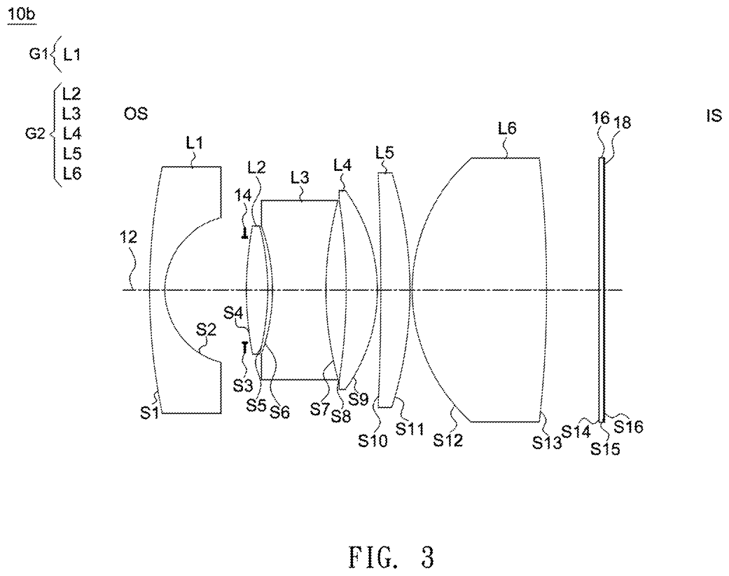

FIG. 3 shows a cross-sectional illustration of an imaging lens according to a second embodiment of the invention. In this embodiment, the imaging lens 10b includes a lens L1, a lens L2, a lens L3, a lens L4, a lens L5 and a lens L6 with refractive powers arranged in order from the object side OS to the image side IS and includes an aperture stop 14 disposed between the lens L1 and the lens L2. The refractive powers of the lenses L1-L6 are negative, positive, negative, positive, positive and positive, respectively. In this embodiment, the lens L1, the lens L2, the lens L3, the lens L4, the lens L5 and the lens L6 are all glass spherical lenses.

In this embodiment, the imaging lens 10b includes six lenses with refractive powers. As to the imaging lens 10b of this embodiment, an effective focal length (EFL) is 10.98 mm, an F-number (F #) is 1.3, a diagonal field of view DFOV is 124 degrees, a total track length (an axial distance between the object side surface of the lens closest to the object side OS and the image plane 18) TTL is 56.5 mm, a total lens length LT is 49.26 mm, a maximum image height IMH is 10.51 mm, a lens diameter D1 of the lens closest to the object side OS is 28.2 mm, a lens diameter DL of the lens closest to the image side IS is 26.2 mm, D1/LT=0.57, DL/LT=0.53, LT/EFL=4.49, and IMH/LT=0.21.

Detailed optical data and design parameters of the lenses and other optical components of the imaging lens 10b are shown in Table 2.

TABLE 2

| | | Radius of | Interval | Refractive | Abbe |
|---|---|---|---|---|---|
| Object description | Surface | curvature(mm) | (mm) | index (nd) | number (Vd) |
| Lens L1(meniscus) | S1 | 72.557 | 2.042 | 1.516 | 64 |
| | S2 | 9.085 | 9.922 | | |
| Aperture stop 14 | S3 | INF | 0.200 | | |
| Lens L2(bi-convex) | S4 | 45.155 | 2.642 | 2.001 | 29 |
| | S5 | −30.959 | 0.508 | | |
| Lens L3(bi-concave) | S6 | −23.491 | 6.655 | 1.613 | 44 |
| | S7 | 35.282 | 2.616 | | |
| Lens L4(meniscus) | S8 | −67.293 | 3.800 | 2.001 | 29 |
| | S9 | −20.594 | 0.396 | | |
| Lens L5(meniscus) | S10 | −286.989 | 3.711 | 1.904 | 31 |
| | S11 | −45.842 | 0.200 | | |
| Lens L6(bi-convex) | S12 | 21.134 | 16.571 | 1.497 | 82 |
| | S13 | −206.969 | 6.697 | | |
| Optical filter 16 | S14 | INF | 0.500 | 1.517 | 64 |
| | S15 | INF | 0.040 | | |
| Image plane 18 | S16 | INF | 0.000 | | |

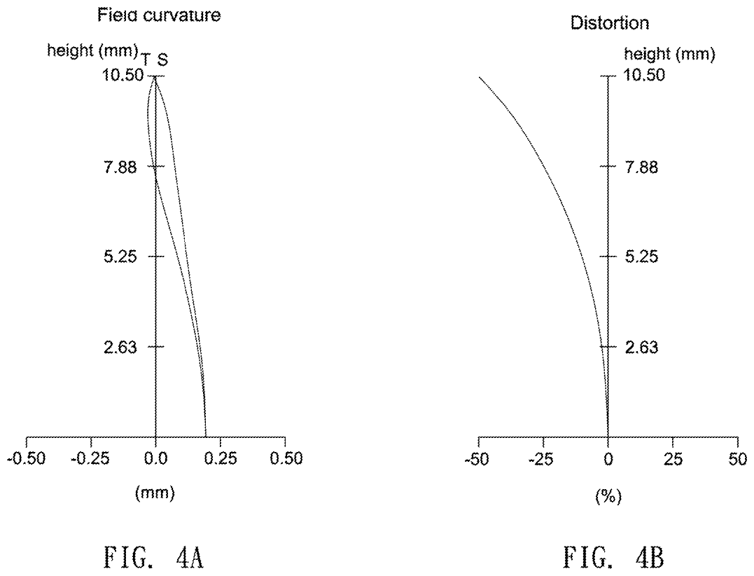

FIG. 4A and FIG. 4B respectively show field curvature and distortion aberration curves of the imaging lens 10b measured at a wavelength of 940 nm. Because the graphs shown in FIG. 4A and FIG. 4B are all within the standard range, it can be verified that the imaging lens 10b can achieve high-resolution infrared imaging effects.

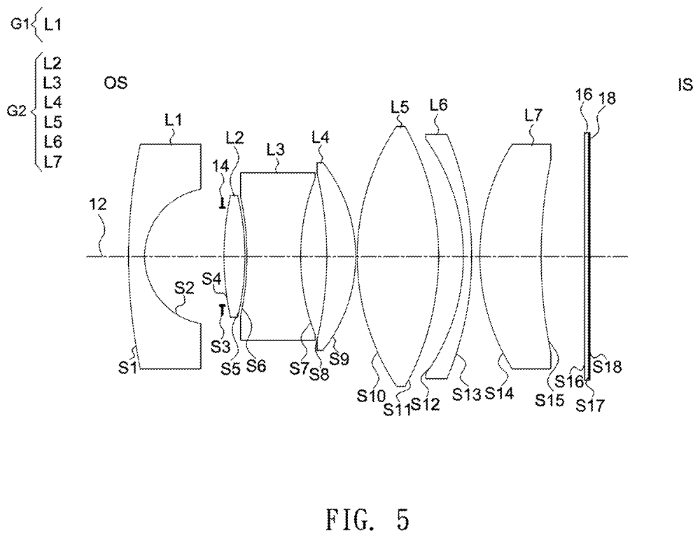

FIG. 5 shows a cross-sectional illustration of an imaging lens according to a third embodiment of the invention. In this embodiment, the imaging lens 10c includes a lens L1, a lens L2, a lens L3, a lens L4, a lens L5, a lens L6 and a lens L7 with refractive powers arranged in order from the object side OS to the image side IS. As compared with the imaging lens 10b shown in FIG. 3, the imaging lens 10c shown in FIG. 5 further includes a seventh lens (lens L5). An aperture stop 14 is disposed between the lens L1 and the lens L2, and the refractive powers of the lenses L1-L7 are negative, positive, negative, positive, positive, negative and positive, respectively. In this embodiment, the lenses L1-L7 are all glass spherical lenses.

In this embodiment, the imaging lens 10c includes seven lenses with refractive powers. As to the imaging lens 10c of this embodiment, an effective focal length (EFL) is 11.01 mm, an F-number (F #) is 1.3, a diagonal field of view DFOV is 124 degrees, a total track length TTL is 56.5 mm, a total lens length LT is 50.65 mm, a maximum image height IMH is 10.51 mm, a lens diameter D1 of the lens closest to the object side OS is 27.7 mm, a lens diameter DL of the lens closest to the image side IS is 24.2 mm, D1/LT=0.55, DL/LT=0.48, LT/EFL=4.60, and IMH/LT=0.21.

Detailed optical data and design parameters of the lenses and other optical components of the imaging lens 10c are shown in Table 3.

TABLE 3

| | | Radius of | Interval | Refractive | Abbe |
|---|---|---|---|---|---|
| Object description | Surface | curvature(mm) | (mm) | index (nd) | number (Vd) |
| Lens L1(meniscus) | S1 | 76.027 | 2.035 | 1.516 | 64 |
| | S2 | 8.914 | 9.488 | | |
| Aperture stop 14 | S3 | INF | 0.200 | | |
| Lens L2(bi-convex) | S4 | 42.825 | 2.574 | 2.001 | 29 |
| | S5 | −39.452 | 0.274 | | |
| Lens L3(bi-concave) | S6 | −36.518 | 6.586 | 1.613 | 44 |
| | S7 | 30.098 | 3.160 | | |
| Lens L4(meniscus) | S8 | −51.920 | 3.590 | 2.001 | 29 |
| | S9 | −20.757 | 0.200 | | |
| Lens L5(bi-convex) | S10 | 32.362 | 9.995 | 1.834 | 37 |
| | S11 | −37.582 | 3.034 | | |
| Lens L6(meniscus) | S12 | −26.964 | 1.000 | 1.752 | 25 |
| | S13 | −43.855 | 0.992 | | |
| Lens L7(meniscus) | S14 | 29.416 | 7.517 | 1.497 | 82 |
| | S15 | 64.056 | 5.314 | | |
| Optical filter 16 | S16 | INF | 0.500 | 1.517 | 64 |
| | S17 | INF | 0.040 | | |
| Image plane 18 | S18 | INF | 0.000 | | |

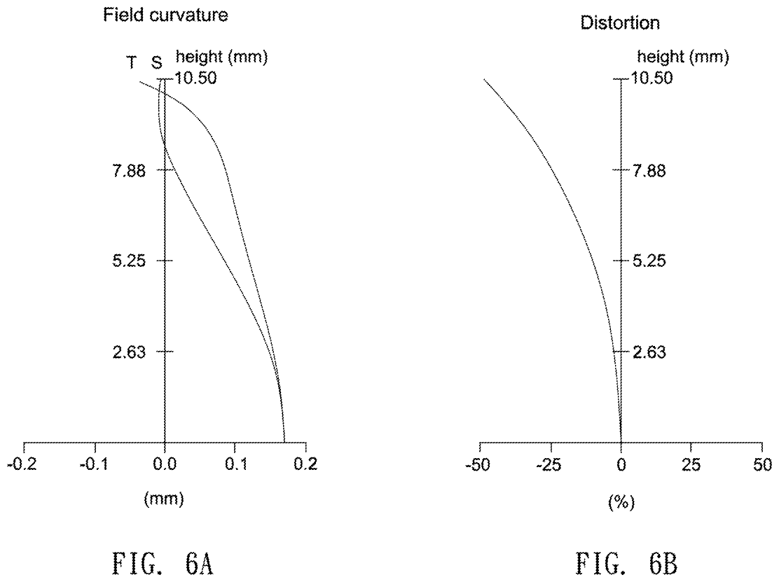

FIG. 6A and FIG. 6B respectively show field curvature and distortion aberration curves of the imaging lens 10c measured at a wavelength of 940 nm. Because the graphs shown in FIG. 6A and FIG. 6B are all within the standard range, it can be verified that the imaging lens 10c can achieve high-resolution near-infrared imaging effects.

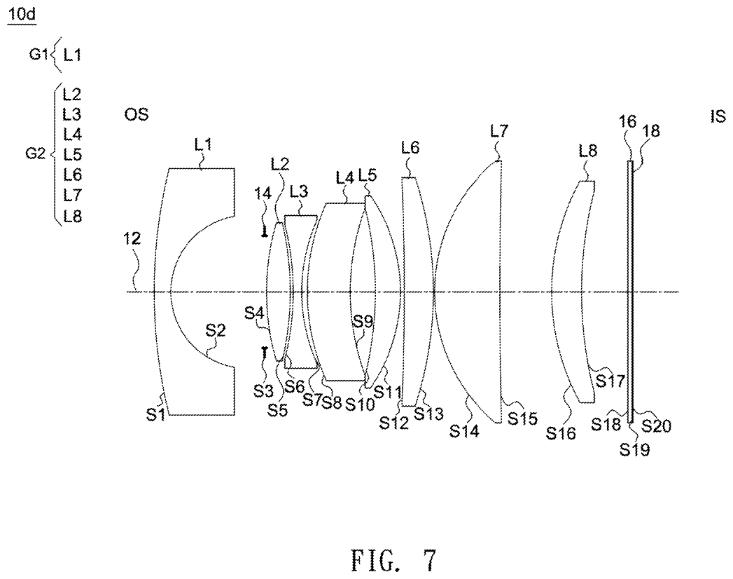

FIG. 7 shows a cross-sectional illustration of an imaging lens according to a fourth embodiment of the invention. In this embodiment, the imaging lens 10d includes a lens L1, a lens L2, a lens L3, a lens LA, a lens L5, a lens L6, a lens L7 and a lens L8 with refractive powers arranged in order from the object side OS to the image side IS. As compared with the imaging lens 10c shown in FIG. 5, the imaging lens 10d shown in FIG. 7 further includes an eighth lens (lens L8). An aperture stop 14 is disposed between the lens L1 and the lens L2, and the refractive powers of the lenses L1-L8 are negative, positive, negative, positive, positive, positive, positive and positive, respectively. In this embodiment, the lenses L1-L8 are all glass spherical lenses.

In this embodiment, the imaging lens 10d includes eight lenses with refractive powers. As to the imaging lens 10d of this embodiment, an effective focal length (EFL) is 10.97 mm, an F-number (F #) is 1.3, a diagonal field of view DFOV is 124 degrees, a total track length TTL is 56.5 mm, a total lens length LT is 50.5 mm, a maximum image height IMH is 10.52 mm, a lens diameter D1 of the lens closest to the object side OS is 28.2 mm, a lens diameter DL of the lens closest to the image side IS is 24.2 mm, D1/LT=0.56, DL/LT=0.48, LT/EFL=4.60, and IMH/LT=0.21.

Detailed optical data and design parameters of the lenses and other optical components of the imaging lens 10d are shown in Table 4.

TABLE 4

| | | Radius of | Interval | Refractive | Abbe |
|---|---|---|---|---|---|
| Object description | Surface | curvature(mm) | (mm) | index (nd) | number (Vd) |
| Lens L1(meniscus) | S1 | 69.984 | 2.038 | 1.589 | 61 |
| | S2 | 9.311 | 11.011 | | |
| Aperture stop 14 | S3 | INF | 0.200 | | |
| Lens L2(bi-convex) | S4 | 32.761 | 2.777 | 2.001 | 29 |
| | S5 | −43.516 | 0.355 | | |
| Lens L3(bi-concave) | S6 | −36.039 | 1.000 | 1.516 | 64 |
| | S7 | 21.233 | 0.682 | | |
| Lens L4(meniscus) | S8 | 29.514 | 5.006 | 1.752 | 25 |
| | S9 | 31.522 | 2.945 | | |
| Lens L5(meniscus) | S10 | −47.877 | 3.126 | 2.003 | 19 |
| | S11 | −21.495 | 0.200 | | |
| Lens L6(meniscus) | S12 | −1240.547 | 3.604 | 1.904 | 31 |
| | S13 | −51.863 | 0.200 | | |
| Lens L7(meniscus) | S14 | 22.002 | 7.901 | 1.497 | 82 |
| | S15 | 3910.214 | 5.969 | | |
| Lens L8(meniscus) | S16 | 29.864 | 3.484 | 1.497 | 82 |
| | S17 | 56.974 | 5.462 | | |
| Optical filter 16 | S18 | INF | 0.500 | | |
| | S19 | INF | 0.04 | | |
| Image plane 18 | S20 | INF | 0 | | |

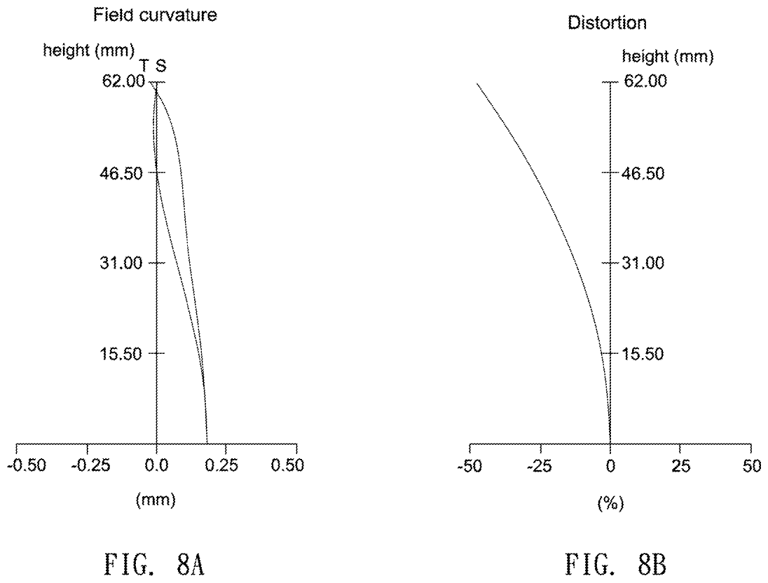

FIG. 8A and FIG. 8B respectively show field curvature and distortion aberration curves of the imaging lens 10d measured at a wavelength of 940 nm. Because the graphs shown in FIG. 8A and FIG. 8B are all within the standard range, it can be verified that the imaging lens 10d can achieve high-resolution near-infrared imaging effects.

According to the above embodiments, meeting the designed characteristics and arrangement of optical components set forth in the above may achieve good quality for infrared imaging and achieve a miniaturized lens assembly having a wide field of view, a large effective aperture and a large image height. Further, in order to meet specific requirements for the application of in-vehicle cameras, each lens element of the imaging lens can be a glass lens to allow for a wide working temperature range and ensure stable image qualities under harsh environments with large temperature differences. Through the designs of various embodiments of the invention, the imaging lens can provide at least one of the advantages of wide viewing angles, large effective apertures, low thermal drift, wide working temperature ranges, and high-resolution infrared imaging qualities.

Though the embodiments of the invention have been presented for purposes of illustration and description, they are not intended to be exhaustive or to limit the invention. Accordingly, many modifications and variations without departing from the spirit of the invention or essential characteristics thereof will be apparent to practitioners skilled in this art. It is intended that the scope of the invention be defined by the claims appended hereto and their equivalents in which all terms are meant in their broadest reasonable sense unless otherwise indicated.

What is claimed is:

1. An imaging lens, comprising:
a first lens, a second lens, a third lens, a fourth lens, a fifth lens and a sixth lens with refractive powers arranged in order from an object side to an image side of the imaging lens, wherein a total number of lenses with refractive powers of the imaging lens is at most eight; and
an aperture stop dividing the lenses with refractive powers to define a first lens group between the object side and the aperture stop, and the first lens group having a negative refractive power;
wherein the imaging lens is configured to focus only in a wavelength range of infrared light, and the imaging lens satisfies the conditions of 90°<DFOV<140°, Fno<1.6, and LT/EFL<5.0, where Fno is an F-number of the imaging lens, DFOV is a maximum diagonal field of view of the imaging lens, EFL is an effective focal length of the imaging lens, and LT is a distance measured along an optical axis between two outermost lens surfaces with refractive powers at opposite ends of the imaging lens.

2. The imaging lens as claimed in claim 1, wherein each of the first lens, the second lens, the third lens, the fourth lens, the fifth lens and the sixth lens is a glass spherical lens, and the second lens and the third lens are paired together to form a doublet lens.

3. The imaging lens as claimed in claim 1, wherein the aperture stop is disposed between the first lens and the third lens.

4. The imaging lens as claimed in claim 1, wherein a total track length of the imaging lens is smaller than 60 mm.

5. The imaging lens as claimed in claim 1, wherein the imaging lens satisfies a condition of 0.2<IMH/LT<0.3, and IMH is a maximum image height of the imaging lens.

6. The imaging lens as claimed in claim 1, wherein the first lens is closest to the object side as compared with any other lens of the imaging lens, the imaging lens satisfies a condition of 0.5<D1/LT<0.65, and D1 is a lens diameter of the first lens.

7. The imaging lens as claimed in claim 1, wherein the sixth lens is closest to the image side as compared with any other lens of the imaging lens, the imaging lens satisfies a condition of 0.5<DL/LT<0.65, and DL is a lens diameter of the sixth lens.

8. The imaging lens as claimed in claim 1, wherein the first lens, the second lens, the third lens, the fourth lens, the fifth lens and the sixth lens respectively have refractive powers of negative, positive, negative, positive, positive, positive.

9. The imaging lens as claimed in claim 1, further comprising a seventh lens disposed between the fourth lens and the fifth lens.

10. The imaging lens as claimed in claim 1, further comprising an eighth lens disposed between the sixth lens and an image plane.

11. An imaging lens, comprising:
a first lens, a second lens, a third lens, a fourth lens, a fifth lens and a sixth lens with refractive powers arranged in order from an object side to an image side of the imaging lens, wherein a total number of lenses with refractive powers of the imaging lens is at most eight; and
an aperture stop dividing the lenses with refractive powers to define a first lens group between the object side and the aperture stop, and the first lens group having a negative refractive power;
wherein the imaging lens is configured to focus only in a wavelength range of infrared light, and the imaging lens satisfies the conditions of 90°<DFOV<140°, Fno<1.6 and 9 mm<IMH<12 mm, where Fno is an F-number of the imaging lens, DFOV is a maximum diagonal field of view of the imaging lens, and IMH is a maximum image height.

12. The imaging lens as claimed in claim 11, wherein each of the first lens, the second lens, the third lens, the fourth lens, the fifth lens and the sixth lens is a glass spherical lens, and the second lens and the third lens are paired together to form a doublet lens.

13. The imaging lens as claimed in claim 11, wherein the aperture stop is disposed between the first lens and the third lens.

14. The imaging lens as claimed in claim 11, wherein a total track length of the imaging lens is smaller than 60 mm.

15. The imaging lens as claimed in claim 11, wherein the imaging lens satisfies a condition of 0.2<IMH/LT<0.3, where LT is a distance measured along an optical axis between two outermost lens surfaces with refractive powers at opposite ends of the imaging lens.

16. The imaging lens as claimed in claim 11, wherein the first lens is closest to the object side as compared with any other lens of the imaging lens, the imaging lens satisfies a condition of 0.5<D1/LT<0.65, where LT is a distance measured along an optical axis between two outermost lens surfaces with refractive powers at opposite ends of the imaging lens, and D1 is a lens diameter of the first lens.

17. The imaging lens as claimed in claim 11, wherein the sixth lens is closest to the image side as compared with any other lens of the imaging lens, the imaging lens satisfies a condition of 0.5<DL/LT<0.65, where LT is a distance measured along an optical axis between two outermost lens surfaces with refractive powers at opposite ends of the imaging lens, and DL is a lens diameter of the sixth lens.

18. The imaging lens as claimed in claim 11, wherein the first lens, the second lens, the third lens, the fourth lens, the fifth lens and the sixth lens respectively have refractive powers of negative, positive, negative, positive, positive, positive.

19. The imaging lens as claimed in claim 11, further comprising a seventh lens disposed between the fourth lens and the fifth lens.

20. The imaging lens as claimed in claim 11, further comprising an eighth lens disposed between the sixth lens and an image plane.
